(19) United States
(12) Patent Application Publication
(10) Pub. No.: US 2013/0333148 A1
(43) Pub. Date: Dec. 19, 2013

(54) WIPER BLADE DEVICE

(71) Applicants: Koen Bex, Jeuk (BE); Dirk Herinckx, Linter (BE); Helmut Depondt, Kessel-Lo (BE)

(72) Inventors: Koen Bex, Jeuk (BE); Dirk Herinckx, Linter (BE); Helmut Depondt, Kessel-Lo (BE)

(73) Assignee: ROBERT BOSCH GMBH, Stuttgart (DE)

(21) Appl. No.: 13/994,084

(22) PCT Filed: Nov. 8, 2011
(86) PCT No.: PCT/EP2011/069624

§ 371 Date: Aug. 28, 2013

(30) Foreign Application Priority Data
Dec. 13, 2010 (DE) 10 2010 062 896.4

(51) Int. Cl. B60S 1/38

(52) U.S. Cl. CPC B60S 1/381
USPC 15/250.201; 29/428

(57) ABSTRACT

The invention relates to a wiper blade device comprising a wiper strip unit (12) which has a wind-deflector element (16), a wiper lip (18) and a wiper strip element (14) comprising a longitudinal guide channel (24) for a support element (20). According to the invention, the wiper strip element (14), in a mounted state, forms an interlocking connection with the wiper lip (18).

### BACKGROUND OF THE INVENTION

The invention is based on a wiper blade device.

A wiper blade device comprising a wiper strip unit which has a wind deflector element, a wiper lip and a wiper strip element which comprises a longitudinal guide channel for a support element is already known.

### SUMMARY OF THE INVENTION

The invention is based on a wiper blade device comprising a wiper strip unit which has a wind deflector element, a wiper lip and a wiper strip element which comprises a longitudinal guide channel for a support element.

It is proposed that, in a fitted state, the wiper strip element forms an interlocking connection with the wiper lip, as a result of which particularly rapid installation of the wiper blade device can be achieved. A “wiper strip unit” in this context should be particularly taken to mean a unit which is provided to connect a wiper blade adaptor to a wiper lip. “Provided” should be particularly taken to mean specially designed and/or equipped. A “wiper blade adaptor” in this context should be particularly taken to mean an adaptor which is provided to supply a coupling region of the wiper blade device for coupling to a wiper arm. A “wind deflector element” in this context should be particularly taken to mean an element which is provided to deflect an air stream acting on the wiper blade device and/or to be used to press the wiper lip onto a vehicle windscreen. The wind deflector element preferably has at least one concave surface. A “longitudinal guide channel” in this context should be taken particularly to mean a guide channel which, in the fitted state, extends in a main direction of extent parallel to a longitudinal direction of the wiper strip unit. A “longitudinal direction” in this context should be particularly taken to mean a direction which extends substantially parallel to a longitudinal extent of the support element. A “longitudinal extent” in this context should be particularly taken to mean an extension which is as large as possible. “Substantially” in this context should be particularly taken to mean a deviation smaller than 10°, preferably smaller than 5°. An “extension” of an element in this context should be particularly understood to mean a maximum distance between two points on a perpendicular projection of the element onto a plane. A “support element”, in this context should be particularly taken to mean a spring-elastic element which has at least one extent which, in a normal operating state, is elastically variable by at least 10%, in particular by at least 20%, preferably by at least 30% and particularly advantageously by at least 50%, and which particularly generates a counterforce which is dependent on a change in the extent and is preferably proportional to said change and which counteracts said change.

In a further refinement of the invention, it is proposed that the wiper strip element is formed integrally with the wind deflector element, thus enabling a particularly durable connection to be produced between wiper strip element and wind deflector element. “Integrally” should be taken particularly to mean integrally bonded, such as, for example, by means of a welding process and/or adhesive bonding process, etc., and is particularly advantageously taken to mean molded on, such as by production from a casting and/or by production in a single-component or multi-component injection molding process.

If the wiper strip unit comprises a spring-elastic support element which, in a fitted state, forms an interlocking connection with the wiper strip element, the support element can be securely held in the wiper strip unit.

If the wiper blade device has a wiper blade adaptor which, in a fitted state, forms an interlocking connection with the wiper strip unit, a particularly simple and secure coupling to a further component, such as a wiper arm, can be produced.

Furthermore, it is proposed that the wiper blade adaptor has a longitudinal guide unit which is provided to receive the support element in an interlocking manner, thus enabling the support element to be particularly securely held. A “longitudinal guide unit” in this context should be particularly taken to mean a unit which is provided to supply guidance of a support element in the longitudinal direction. The longitudinal guide unit preferably has at least one guide groove which extends in the longitudinal direction and is provided to form an interlocking connection with the support unit.

If, in a fitted state, the longitudinal guide channel and the wiper lip guide unit are closed in an integrally bonded manner in at least one end region, a movement of the support element in the longitudinal direction relative to the wiper strip element can be particularly reliably avoided.

In a further refinement of the invention, it is proposed that the wiper strip element and the wind deflector element are produced in a co-extrusion process, thus enabling a particularly stable and cost-effective production to be obtained.

If the wiper lip and the wiper strip element are connected in an interlocking manner, the wiper blade device can be installed particularly rapidly.

Installation of the wiper blade device can be further accelerated if, after the wiper lip and the wiper strip element are connected in an interlocking manner, a support element is pushed into the wiper strip element and forms an interlocking connection with a wiper blade adaptor.

The wiper blade device can be formed in a particularly stable manner if, after the support element is pushed into the wiper strip element, the longitudinal guide channel is closed in an integrally bonded manner in at least one end region.

### BRIEF DESCRIPTION OF THE DRAWINGS

Further advantages emerge from the description below of the drawing. The drawing illustrates an exemplary embodiment of the invention. The drawing, the description and the claims contain numerous features in combination. A person skilled in the art will expediently also consider the features individually and put them together to form meaningful further combinations.

In the figures:

FIG. 1 shows a perspective view of a wiper blade device according to the invention in a fitted state,

FIG. 2 shows a perspective view of a wiper blade adaptor of the wiper blade device according to FIG. 1,

FIG. 3 shows a perspective view of a wiper strip unit of the wiper blade device according to FIG. 1,

FIG. 4 shows a perspective view of a wiper blade adaptor receiving region of the wiper strip unit according to FIG. 3,

FIG. 5 shows a sectional illustration through the wiper strip unit according to FIG. 3,

FIG. 6 shows a perspective view of a support element of the wiper strip unit according to FIG. 3,

FIG. 7 shows a perspective view of the wiper blade device according to FIG. 1 in a first installation step,

FIG. 8 shows a perspective view of the wiper blade device according to FIG. 1 in a second installation step,

FIG. 9 shows a perspective view of the wiper blade device according to FIG. 1 in a third installation step, and

FIG. 10 shows a perspective view of the wiper blade device according to FIG. 1 in a fourth installation step.

### DETAILED DESCRIPTION

FIG. 1 shows a perspective view of a wiper blade device according to the invention with a wiper strip unit 12 which has a wind deflector element 16, a wiper lip 18 and a wiper strip element 14. The wiper strip element 14 and the wind deflector element 16 are produced in a co-extrusion process and are formed integrally. Other manufacturing processes appearing expedient to a person skilled in the art, such as, in particular, other injection molding processes, adhesive bonding processes and/or welding processes, which lead at least to an integrally bonded connection between the wiper strip element 14 and the wind deflector element 16, are also conceivable in this context. A wiper blade adaptor 10 is fastened to the wiper strip unit 12.

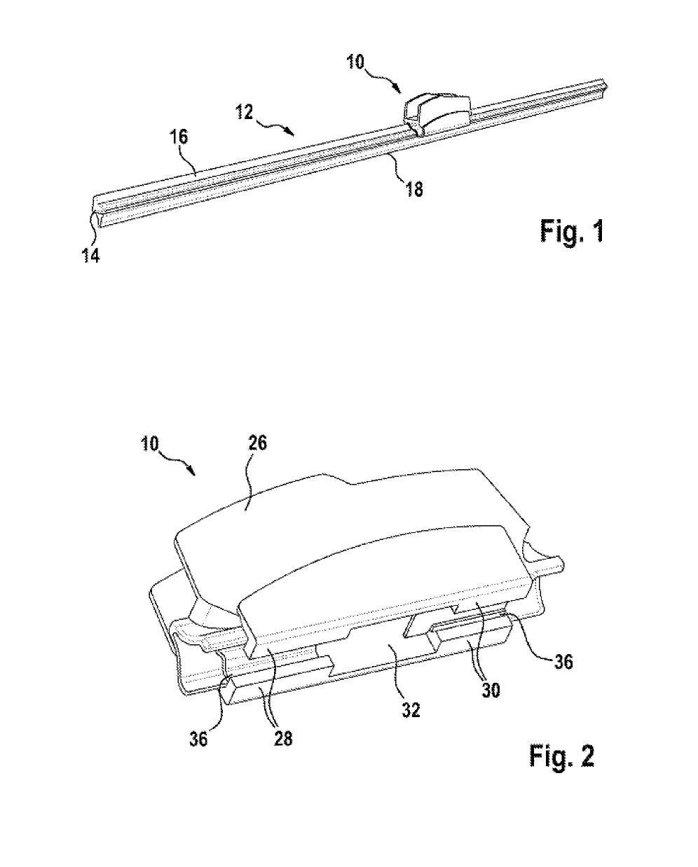

FIG. 2 shows a perspective view of the wiper blade adaptor 10 which has a basic body 26 on which two fastening means 28, 30 are molded. The fastening means 28, 30 are adjacent to a central recess 32 of the basic body 26.

The wiper blade adaptor 10 contains a longitudinal guide unit 34 which comprises four guide grooves 36. The guide grooves 36 are open toward one another and extend parallel to a main longitudinal extent of the wiper blade adaptor 10. In a fitted state, the main longitudinal extent of the wiper blade adaptor 10 runs parallel to a longitudinal direction 22 of the wiper strip unit 12. The longitudinal direction 22 extends parallel to a longitudinal extent of the wiper strip unit 12. Furthermore, the guide grooves 36 are adjacent to the central recess 32.

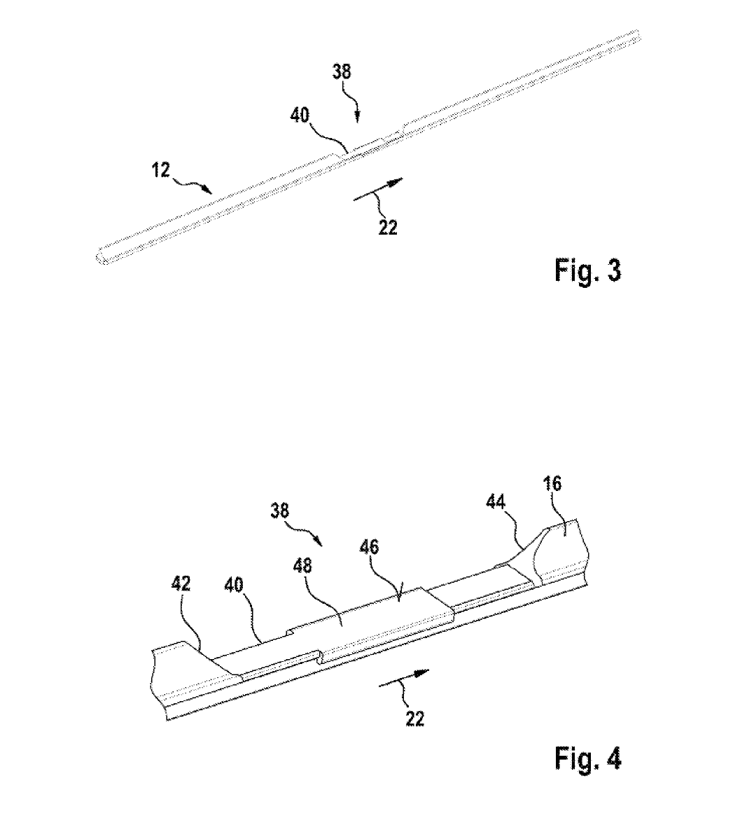

FIG. 3 illustrates a wiper strip unit 12 according to the invention. The wind deflector element 16 has a fastening recess 40 in a wiper blade adaptor receiving region 38 which, as viewed in the longitudinal direction 22, extends from 45% to 55% of the longitudinal extent of the wiper strip unit 12. The wind deflector element 16 is rounded at each free end toward the wiper lip 18.

A longitudinal guide channel 24 for receiving a spring-elastic support element 20 runs in the longitudinal direction 22 in the wiper strip element 14. The longitudinal guide channel 24 has an identical cross section to the support element 20. When the support element 20 is pushed into the longitudinal guide channel 24, an interlocking connection is formed.

FIG. 4 shows the wiper blade adaptor receiving region 38 of the wiper strip unit 12 in a perspective view. The fastening recess 40 is adjacent to two side walls 42, 44 of the wind deflector element 16. The wiper strip element 14 has a bearing surface 46. The side walls 42, 44 enclose an angle of 45° with the longitudinal direction 22. The side walls 42, 44 enclose an angle of 90° with each other. The bearing surface 46 is located on a bearing body 48 which is arranged centrally in the fastening recess 40.

The longitudinal guide channel 24 of the wiper strip unit 12 is open at the side walls 42, 44. The bearing body 48 continues the longitudinal guide channel 24 within the wiper blade adaptor receiving region 38.

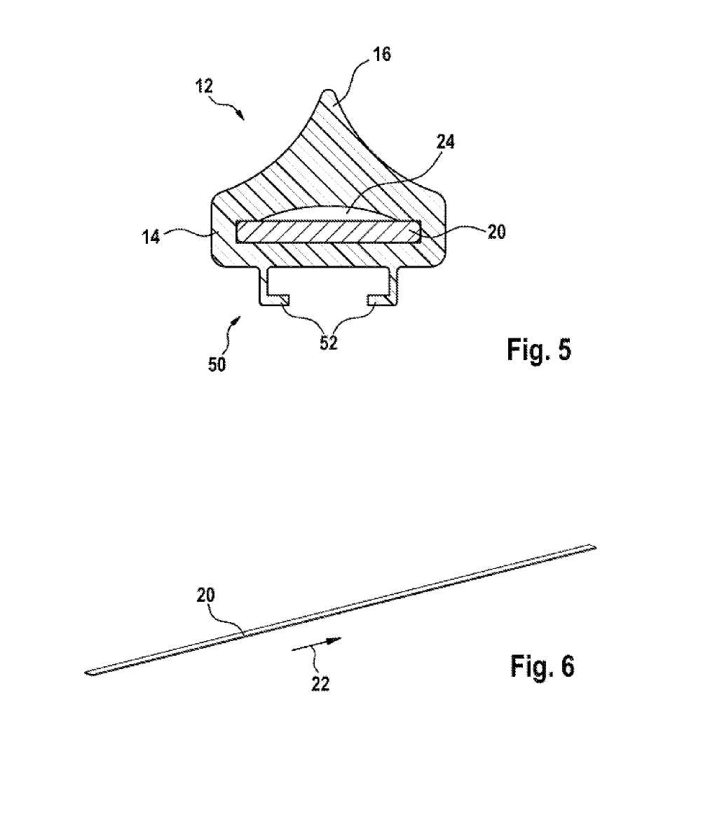

FIG. 5 shows a section through the wiper strip unit 12. A wiper lip guide unit 50 of the wiper strip element 14, which has two L-shaped guide profiles 52, is arranged on a side opposite the wind deflector element 16. In a fitted state, a coupling component of the wiper lip 18 is arranged within the wiper lip guide unit 50 and forms an interlocking connection with the guide profiles 52.

FIG. 6 illustrates the spring-elastic support element 20 which is composed of a spring steel. The support element 20 is of a thickness which corresponds to a width of the guide grooves 36.

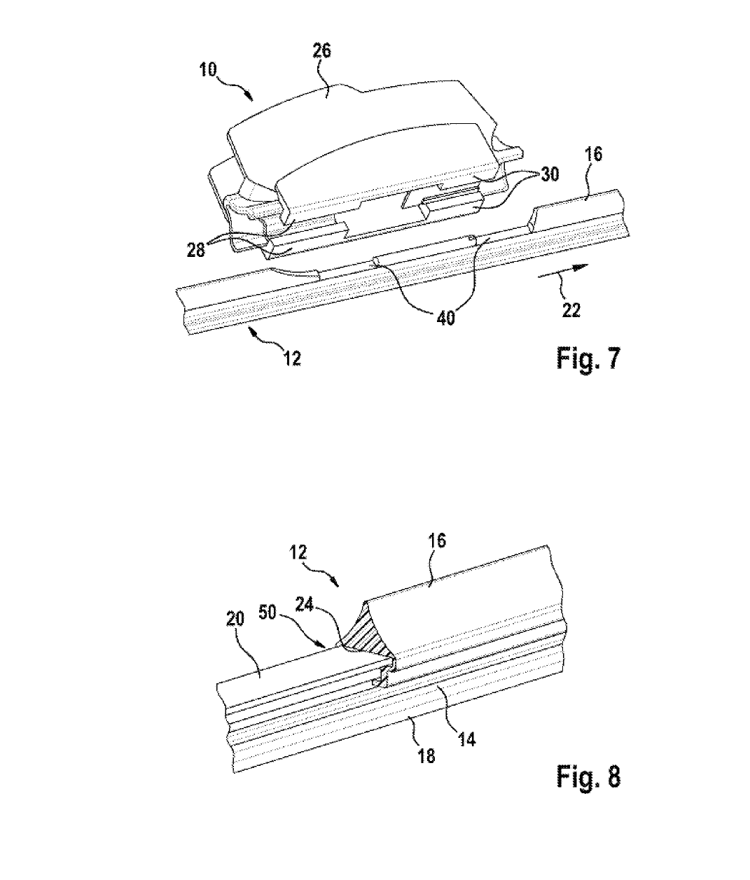

FIG. 7 illustrates a first installation step of the wiper blade device. The wiper blade adaptor 10 is placed onto the wiper strip unit 12. In the process, the fastening means 28, 30 of the wiper blade adaptor 10 engage in an interlocking manner in the fastening recess 40 of the wiper strip unit 12. In a fitted state, the wiper blade adaptor 10 rests on the bearing surface 46. The wiper blade adaptor 10 forms an interlocking connection with the wiper strip unit 12. A movement of the wiper strip unit 12 relative to the wiper blade adaptor 10 is avoided in the longitudinal direction 22.

In a second installation step, as illustrated in FIG. 8, the wiper lip 18 is pushed into the wiper lip guide unit 50 and forms an interlocking connection therewith. As a result, in a fitted state, the wiper strip element 14 forms an interlocking connection with the wiper lip 18. Furthermore, the support element 20 is inserted into the longitudinal guide channel 24 of the wiper strip element 14. As a result, in a fitted state, the support element 20 forms an interlocking connection with the wiper strip element 14.

The support element 20 emerges from the longitudinal guide channel 24 in the wiper blade adaptor receiving region 38 and is subsequently guided in the longitudinal guide unit 34 of the wiper blade adaptor 10.

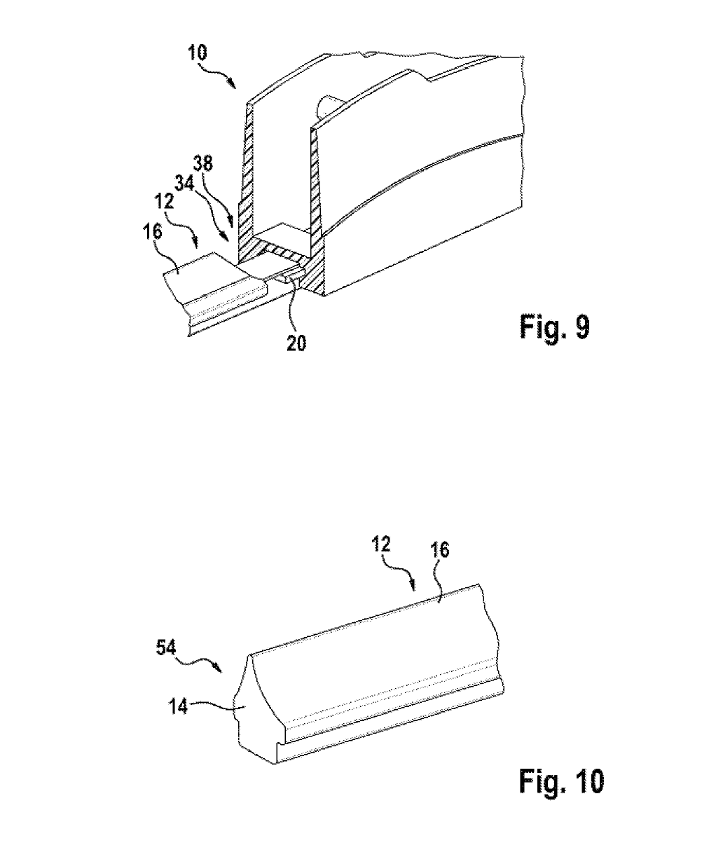

FIG. 9 shows the support element 20 which has been pushed completely through the longitudinal guide unit 34. The support element 20 forms an interlocking connection with the wiper blade adaptor 10. The wiper blade adaptor 10 is connected fixedly to the wiper strip unit 12.

In a third installation step, the support element 20 is pushed further until it is located completely in the wiper strip unit 12. In order to avoid a movement of the support element 20 relative to the wiper strip unit 12, the wiper strip element 14 is melted in end regions 54 of the longitudinal extent of the wiper strip unit 12, as illustrated in a fourth installation step in FIG. 10. As a result, the longitudinal guide channel 24 and the wiper lip guide unit 50 are closed in an integrally bonded manner in the two end regions 54 thereof. For the sake of clarity, the wiper lip 18 is not illustrated in FIG. 10. A movement of the support element 20 within the longitudinal guide channel 24 is avoided in any direction.

1. A wiper blade device comprising a wiper strip unit (12) which has a wind deflector element (16), a wiper lip (18) and a wiper strip element (14) which comprises a longitudinal guide channel (24) for a support element (20), characterized in that, in a fitted state, the wiper strip element (14) forms an interlocking connection with the wiper lip (18).

2. The wiper blade device as claimed in claim 1, characterized in that the wiper strip element (14) is formed integrally with the wind deflector element (16).

3. The wiper blade device as claimed in claim 1, characterized in that the wiper strip unit (12) comprises a spring-elastic support element (20) which, in a fitted state, forms an interlocking connection with the wiper strip element (14).

4. The wiper blade device as claimed in claim 1, characterized by a wiper blade adapter (10) which, in a fitted state, forms an interlocking connection with the wiper strip unit (12).

5. The wiper blade device as claimed in claim 4, characterized in that the wiper blade adaptor (10) has a longitudinal guide unit (34) which receives the support element (20) in an interlocking manner.

6. The wiper blade device as claimed in claim 1, characterized in that, in a fitted state, the longitudinal guide channel (24) is closed in an integrally bonded manner in at least one end region (54).

7. The wiper blade device as claimed in claim 1, characterized in that the wiper strip element (14) and the wind deflector element (16) are produced in a co-extrusion process.

8. A wiper strip element of a wiper blade device as claimed in claim 1.

9. A wiper lip (18) of a wiper blade device as claimed in claim 1.

10. A wiper blade adaptor (10) of a wiper blade device as claimed in claim 4.

11. A method for installing a wiper blade device as claimed in claim 1, characterized in that the wiper lip (18) and the wiper strip element (14) are connected in an interlocking manner.

12. The method as claimed in claim 11, characterized in that, after the wiper lip (18) and the wiper strip element (14) are connected in an interlocking manner, a support element (20) is pushed into the wiper strip element (14) and forms an interlocking connection with a wiper blade adaptor (10).

13. The method as claimed in claim 12, characterized in that, after the support element (20) is pushed into the wiper strip element (14), the longitudinal guide channel (24) is closed in an integrally bonded manner in at least one end region (54).
